(19) United States
(12) Patent Application Publication
(10) Pub. No.: US 2025/0311731 A1
(43) Pub. Date: Oct. 9, 2025

(54) SPRAY-DRIED PEST CONTROL COMPOSITIONS

(71) Applicants: Dow Global Technologies LLC, Midland, MI (US); Rohm and Haas Company, Collegeville, PA (US)

(72) Inventors: Selvanathan Arumugam, West Chester, PA (US); Caroline Woelfle-Gupta, Midland, MI (US); Douglas Hasso, Auburn, MI (US); Liang Chen, Sewickley, PA (US); Daniel A. Saucy, Harleysville, PA (US); Susan L. Jordan, Doylestown, PA (US); Yujing Tan, Midland, MI (US)

(21) Appl. No.: 18/863,229

(22) PCT Filed: May 31, 2022
(86) PCT No.: PCT/US2022/031538

§ 371 Date: Nov. 5, 2024

(51) Int. Cl. A01N 63/23; A01N 25/10; A01N 25/12; A01P 7/04

(52) U.S. Cl. CPC A01N 63/23; A01N 25/10; A01N 25/12; A01P 7/04

(57) ABSTRACT

A spray-dried pest control composition includes a polymer, wherein the polymer has a weight average molecular weight from 10,000 to 30,000 daltons and the polymer contains from 20 wt % to 100 wt % of monomeric structural units derived from a monomer with log P of from 2.0 to 6.0 based upon a total weight of the polymer and Bacillus thuringiensis, wherein the spray-dried pest control composition has an average particle diameter from 30 nanometers to 100 microns as measured using Laser Diffraction.

### FIELD OF DISCLOSURE

The present disclosure relates to spray dried pest control compositions, and specifically to spray dried pest control compositions comprising Bacillus thuringiensis.

### BACKGROUND

Pest control agents are utilized to control pests, such as insects. The effectiveness of pest control agents can be influenced by a number of factors. There is continued focus in the industry on developing new and improved pest control compositions.

### SUMMARY OF THE DISCLOSURE

According to a first feature of the present disclosure, a spray-dried pest control composition includes a polymer, wherein the polymer has a weight average molecular weight from 10,000 to 30,000 daltons and the polymer contains from 20 wt % to 100 wt % of monomeric structural units derived from a monomer with log P of from 2.0 to 6.0 based upon a total weight of the polymer and Bacillus thuringiensis, wherein the spray-dried pest control composition has an average particle diameter from 30 nanometers to 100 microns as measured using Laser Diffraction. According to a second feature of the present disclosure, the polymer is from 50.0 wt % to 99.0 wt % of the composition based upon a total weight of a combination of the polymer and the Bacillus thuringiensis; and the pest control agent is from 1.0 wt % to 50.0 wt % of the Bacillus thuringiensis based upon the total weight of the combination of the polymer and the Bacillus thuringiensis. According to a third feature of the present disclosure, the polymer has a weight average molecular weight from 15,000 to 20,000 daltons. According to a fourth feature of the present disclosure, the spray-dried pest control composition has an average particle diameter from 1 micron to 100 microns as measured according to Laser Diffraction. According to a fifth feature of the present disclosure, the polymer is a copolymer of diisobutylene and maleic anhydride.

### DETAILED DESCRIPTION

Spray-dried pest control compositions are disclosed herein. Embodiments of the present disclosure provide that the spray-dried pest control compositions include a polymer and Bacillus thuringiensis. As used herein, “spray-dried pest control compositions” refer to compositions where the polymer and the Bacillus thuringiensis have been spray-dried.

Spray-dried compositions may be desirable for a number of applications. For instance, spray-dried compositions may advantageously reduce an associated storage space volume, e.g., as compared to non-spray-dried compositions that include a liquid. Additionally, spray-dried compositions may advantageously reduce handling and/or shipping requirements, e.g., as compared to non-spray-dried compositions that include a liquid. However, not all compositions are suitable for spray-drying.

The spray-dried compositions disclosed herein may be utilized to control pests. For instance, a spray-dried composition may be mixed with water to form an aqueous pest control composition. Such aqueous pest control compositions may be applied to plants, e.g., plant surfaces, to control pests. Advantageously, the aqueous pest control compositions disclosed herein may provide an improved, i.e., greater, residual protein concentrations for Bacillus thuringiensis following exposure to rain, as compared to other formulations. The improved residual protein concentrations indicate that the aqueous pest control compositions disclosed herein can provide improved pest control, as compared to other formulations.

Further, the aqueous pest control compositions, which include the spray-dried compositions disclosed herein, may provide an improved, i.e., greater Bacillus thuringiensis activity retained following exposure to rain, as compared to other formulations. The improved Bacillus thuringiensis activity retained indicate that the aqueous pest control compositions disclosed herein can provide improved pest control, as compared to other formulations.

The spray-dried pest control compositions disclosed herein can include a polymer. As used herein, “a” refers to one or more unless indicated otherwise. As used herein a “polymer” has two or more of the same or different monomeric structural units derived from two or more different monomers, e.g., copolymers, terpolymers, etc. “Monomeric structural unit”, as used herein in reference to polymers, indicates a portion of the polymer structure that results from a reaction of a monomer or monomers to form the polymer. “Different” in reference to monomeric structural units indicates that the monomeric structural units differ from each other by at least one atom or are different isomerically. Embodiments of the present disclosure provide that the monomeric structural units of the polymer result, i.e. are formed, from a polymerization reaction of the monomers. One or more embodiments provide that a monomeric structural unit may undergo one or more reactions subsequent to the polymerization reaction, e.g., a hydrolysis reaction.

The polymer may have a weight average molecular weight from 10,000 daltons to 30,000 daltons. For example, the polymer may have a weight average molecular weight of 10,000 daltons or greater, or 11,000 daltons or greater, or 12,000 daltons or greater, or 13,000 daltons or greater, or 14,000 daltons or greater, or 15,000 daltons or greater, or 16,000 daltons or greater, or 17,000 daltons or greater, or 18,000 daltons or greater, or 19,000 daltons or greater, or 20,000 daltons or greater, or 21,000 daltons or greater, or 22,000 daltons or greater, or 23,000 daltons or greater, or 24,000 daltons or greater, or 25,000 daltons or greater, or 26,000 daltons or greater, or 27,000 daltons or greater, or 28,000 daltons or greater, or 29,000 daltons or greater, while at the same time, 30,000 daltons or less, or 29,000 daltons or less, or 28,000 daltons or less, or 27,000 daltons or less, or 26,000 daltons or less, or 25,000 daltons or less, or 24,000 daltons or less, or 23,000 daltons or less, or 22,000 daltons or less, or 21,000 daltons or less, or 20,000 daltons or less, or 19,000 daltons or less, or 18,000 daltons or less, or 17,000 daltons or less, or 16,000 daltons or less, or 15,000 daltons or less, or 14,000 daltons or less, or 13,000 daltons or less, or 12,000 daltons or less or 11,000 daltons or less. The weight average molecular weight of the polymer is determined using gel permeation chromatography.

One or more embodiments of the present disclosure provide that the polymer contains from 20 wt % to 100 wt % of monomeric structural units derived from a monomer, i.e. one or more monomers, with log P of from 2.0 to 6.0, based upon a total weight of the polymer. For example, the polymer may contain 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, while at the same time, 100 wt % or less, or 95 wt % or less, or 90 wt % or less, or 85 wt % or less, or 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less of a monomer with log P of from 2.0 to 6.0.

The polymer may contain greater than 90 wt % of monomeric structural units derived from a monomer with log P of greater than 1.0.

For example, the polymer may contain 91 wt % or greater, or 92 wt % or greater, or 93 wt % or greater, or 94 wt % or greater, or 95 wt % or greater, or 96 wt % or greater, or 97 wt % or greater, or 98 wt % or greater, or 99 wt % or greater, while at the same time, 100 wt % or less, or 99 wt % or less, or 98 wt % or less, or 97 wt % or less, or 96 wt % or less, or 95 wt % or less, or 94 wt % or less, or 93 wt % or less, or 92 wt % or less, or 91 wt % or less of a monomer with log P of 1.0 or greater.

One or more of the monomeric structural units may have a log P of 1.0 or greater, or 1.2 or greater, or 1.4 or greater, or 1.6 or greater, or 1.8 or greater, or 2.0 or greater, or 2.2 or greater, or 2.4 or greater, or 2.6 or greater, or 2.8 or greater, or 3.0 or greater, or 3.2 or greater, or 3.4 or greater, or 3.6 or greater, or 3.8 or greater, or 4.0 or greater, or 4.2 or greater, or 4.4 or greater, or 4.6 or greater, or 4.8 or greater, or 5.0 or greater, or 5.2 or greater, or 5.4 or greater, or 5.6 or greater, or 5.8 or greater, while at the same time, 6.0 or less, or 5.8 or less, or 5.6 or less, or 5.4 or less, or 5.2 or less, or 5.0 or less, or 4.8 or less. or 4.6 or less, or 4.4 or less, or 4.2 or less, or 4.0 or less, or 3.8 or less. or 3.6 or less, or 3.4 or less, or 3.2 or less, or 3.0 or less, or 2.8 or less. or 2.6 or less, or 2.4 or less, or 2.2 or less, or 2.0 or less, or 1.8 or less. or 1.6 or less, or 1.4 or less, or 1.2 or less. Log P values are determined by utilizing the Estimation Programs Interface (EPI) Suite™, (KOWWIN version 1.68) available at https://www.epa.gov/tsca-screening-tools/epi-suitetm-estimation-program-interface.

Exemplary monomer for use in the polymer include diisobutylene (log P of 4.08), butyl methacrylate (log P of 2.75), butyl acrylate (log P of 2.20), methyl methacrylate (log P of 1.28), ethyl acrylate (log P of 1.22), 2-ethylehexyl acrylate (log P of 4.09), styrene (log P of 2.89), maleic anhydride (log P of 1.62), docosyl methacrylate (log P of 11.59), and combinations thereof.

The polymer may comprise structural units from one or more of itaconic acid, fumaric acid, crotonic acid, acrylic acid, methacrylic acid, maleic acid, acryloxypropionic acid, citraconic acid, methyl acrylate, vinyl acetate, and combinations thereof.

The polymer can be prepared using known equipment, reaction components, and reaction conditions. For instance, the polymer can be prepared by known polymerization, e.g., solution polymerization. The solution polymerization of monomers, i.e., monomers discussed herein, can be performed in a non-aqueous solvent, for instance. Suitable solvents include, but are not limited to, toluene, xylenes, propylene glycol, methylethylketone, and combinations thereof. The solution polymerization can include a solvent-soluble initiator. Examples of the initiator include, but are not limited to, t-butylperoctoate, t-butylhydroperoxide, AIBN, 2,2-azobis(2,4-dimethyl-pentanenitrile), t-butylperoxybenzoate, and combinations thereof. The initiator may be used from 0.01 wt % to 1.00 wt %, based on a total weight of monomers utilized in the solution polymerization, for instance. The solution polymerization may utilize a chain transfer agent. Examples of the chain transfer agent include, but are not limited to, 2-mercaptoethanol, 3-methylmercaptopropionic acid, n-dodecylmercaptan, t-dodecylmercaptan, and combinations thereof. The chain transfer agent may be used from 0.01 wt % to 5.00 wt %, based on a total weight of monomers utilized in the solution polymerization, for instance. The use of a mercaptan modifier may reduce the molecular weight of the polymer. Other known components may be utilized for the solution polymerization; different amount of these other known components may be utilized for various applications.

The polymer can be prepared by known polymerization, e.g., emulsion polymerization. The emulsion polymerization may utilize a surfactant. Examples of surfactants include, but are not limited to, anionic surfactants such as sodium laurylsulfate, sodium dodecylbenzenesulfonate, and sodium ethoxylated[C₁₀]alcohol half-ester of sulfosuccinic acid, and combinations thereof. The surfactant may be used from 0.5 wt % to 6.0 wt %, based on a total weight of monomers utilized in the emulsion polymerization, for instance. The emulsion polymerization may utilize an initiator, such as a water-soluble initiator, for instance. Examples of initiators include, but are not limited to, alkali metal persulfates, ammonium persulfate, and combinations thereof. The initiator may be utilized from 0.01 wt % to 1.00 wt %, based on a total weight of monomers utilized in the emulsion polymerization. The emulsion polymerization may utilize a chain transfer mercaptan. Examples of chain transfer mercaptans include, but are not limited to, 2-mercaptopropionic acid, 3-methylmercaptopropionic acid, alkyl mercaptans containing from 4 to 20 carbon atoms, and combinations thereof. The chain transfer mercaptan may be utilized from 0.01 wt % to 5.00 wt % based on a total weight of monomers utilized in the emulsion polymerization. The use of mercaptan modifier may reduce the molecular weight of the polymer. Other known components may be utilized for the emulsion polymerization; different amount of these other known components may be utilized for various applications.

The polymer may be obtained commercially under various tradenames.

As mentioned, a monomeric structural unit of the polymer described herein may undergo one or more reactions subsequent to the polymerization reaction, e.g., a hydrolysis reaction. The hydrolysis reaction can include the hydrolysis of an ester to an acid or the ring-opening of an anhydride to an acid, for example.

The spray-dried pest control compositions disclosed herein include Bacillus thuringiensis. As defined herein, “Bacillus thuringiensis ” is the spores and/or the crystallized proteins of the species Bacillus thuringiensis and includes all Bacillus thuringiensis subspecies exhibiting insecticidal properties. Examples of such subspecies include kurstaki, israelensis and aizawa. The Bacillus thuringiensis may be added to the pesticide formulation as either a solid or as part of a liquid formulation. The presence and subspecies of Bacillus thuringiensis is determined by Random Amplified Polymorphic DNA analysis. A commercially available liquid formulation of Bacillus thuringiensis is THURICIDE™ pesticide available from CERTIS USA, Columbia, Maryland.

The spray-dried pest control compositions can include from 50.0 wt % to 99.0 wt % of the polymer based upon a total weight of a combination of the polymer and the Bacillus thuringiensis. For example, the spray-dried pest control composition can comprise 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater, or 95 wt % or greater, while at the same time, 99 wt % or less, or 95 wt % or less, or 90 wt % or less, or 85 wt % or less, or 80 wt % or less, or 75 wt % or less, or 70 wt % or less, or 65 wt % or less, or 60 wt % or less, or 55 wt % or less of the polymer based on the total weight of the spray-dried composition.

The spray-dried pest control compositions can include from 1.0 wt % to 50.0 wt % of the Bacillus thuringiensis based upon a total weight of a combination of the polymer and the Bacillus thuringiensis. For example, the spray-dried pest control composition can comprise 1 wt % or greater, or 5 wt % or greater, or 10 wt % or greater, or 15 wt % or greater, or 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less, or 20 wt % or less, or 15 wt % or less, or 10 wt % or less, or 5 wt % or less of the Bacillus thuringiensis based on the total weight of the spray-dried composition.

One or more embodiments of the present disclosure provide that the spray-dried pest control compositions disclosed herein can include an additive. Examples of additives include viscosity modifiers, pH modifiers, herbicides, fungicides, surfactants, humectants, drying aids, inert solids, and combinations thereof, among others. Different amount of the additive may be utilized for various applications.

The spray-dried pest control compositions disclosed herein, which include the polymer and the Bacillus thuringiensis, can be prepared using known spray-drying equipment, spray-drying components, and spray-drying conditions.

As an example, the spray-drying can include forming spray particles, e.g., atomization, from a liquid by spraying through a spray nozzle or by utilizing a centrifuge, wherein the liquid is delivered to a centrifugal rotating disc. The spray particles can be dried utilizing a gaseous flow. The gaseous flow can include air or nitrogen, for instance. The spray-drying can occur at different temperatures for different applications. For example, the spray-drying can occur at a temperature from 20° C. to 200° C.

Embodiments of the present disclosure provide that the spray-dried pest control compositions, i.e. the spray-dried particles, have an average particle diameter from 30 nanometers to 100 microns. All individual values and subranges from 30 nanometers to 100 microns are included; for example, the spray-dried pest control composition may have an average particle diameter from a lower limit of 30, 40, 50, 60, 75, 80, or 100 nanometers to an upper limit 100, 75, 50, 25, 10, 5, or 2 microns. Further the average particle diameter may be from 1 micron to 100 microns. As used herein, “average particle diameter” includes “average equivalent spherical diameter”, e.g., for non-spherical particles. Average particle diameter is measured by Laser Diffraction using a BECKMAN COULTER™ LS 13320 laser diffraction particle size analyzer.

Embodiments of the present disclosure provide that the spray-dried pest control compositions can be a powder. As used herein “powder” refers to a non-tacky solid composition. As an example, the powder may contain less than about 20 wt % moisture, e.g., non-solids, based upon a total weight of the powder. The powder may contain less than 10 wt % moisture, less than about 5 wt % moisture, or less than about 3 wt % moisture based upon a total weight of the powder. The spray-dried compositions disclosed herein may be flowable powder. As used herein “flowable” refers to the ability of a composition to be transported by gravity or by conventional mechanical or pneumatic pumping, e.g., transportable from a storage vessel.

As mentioned, the spray-dried compositions disclosed herein may be mixed with water to form an aqueous pest control composition. Such aqueous pest control compositions may be applied to plants, e.g., plant surfaces, to control pests. The aqueous pest control compositions disclosed herein can be formed using known equipment and processes. The components of the aqueous pest control compositions may be combined, e.g., mixed, to form the aqueous pest control compositions. For instance, the components of the aqueous pest control compositions may be added to a vessel and be agitated therein. The components of the aqueous pest control compositions may be combined in any order.

Advantageously, the aqueous pest control compositions disclosed herein may provide an improved, i.e., greater, residual protein concentrations for Bacillus thuringiensis following exposure to rain, as compared to other formulations. Further advantageously, the aqueous pest control compositions, which include the spray-dried compositions disclosed herein, may provide an improved, i.e., greater, Bacillus thuringiensis activity retained following exposure to rain, as compared to other formulations.

The aqueous pest control compositions disclosed herein can include from 0.10 wt % to 20.00 wt % of the spray-dried pest control composition based upon a total weight of a combination of the spray-dried pest control composition and water. All individual values and subranges from 0.10 wt % to 20.00 wt % are included; for example, the aqueous pest control composition can include the polymer from a lower limit of 0.10 wt %, 0.30 wt %, or 0.50 wt % to an upper limit of 20.00 wt %, 15.00 wt %, or 10.00 wt % based upon the total weight of the combination of the spray-dried pest control composition and the water.

The aqueous pest control composition disclosed herein can include from 80.00 wt % to 99.90 wt % of water, based upon a total weight of a combination of the spray-dried pest control composition and the water. All individual values and subranges from 80.00 wt % to 99.89 wt % are included; for example, aqueous pest control composition can include the water from a lower limit of 80.00 wt %, 85.00 wt %, or 90.00 wt % to an upper limit of 99.90 wt %, 99.70 wt %, or 98.50 wt % based upon the total weight of the combination of the spray-dried pest control composition and the water.

One or more embodiments of the present disclosure provide that the spray-dried pest control compositions disclosed herein can include an additive. Examples of additives include viscosity modifiers, pH modifiers, herbicides, fungicides, surfactants, humectants, drying aids, inert solids, and combinations thereof, among others. Different amount of the additive may be utilized for various applications.

The aqueous pest control compositions disclosed herein may be applied to plants, e.g., plant surfaces, to control pests. The aqueous pest control compositions may be applied to plants using known equipment and processes. For instance, the aqueous pest control compositions may be sprayed, sprinkled, and/or poured, among other applications, to plants. Different amounts of the aqueous pest control compositions may be applied to plants for various applications. As mentioned, advantageously, the aqueous pest control compositions disclosed herein may provide an improved, i.e., greater, residual protein concentrations for Bacillus thuringiensis following exposure to rain, as compared to other formulations.

### EXAMPLES

In the Examples, various terms and designations for materials are used including, for instance, the following:

THURICIDE™ Bacillus thuringiensis formulation (pest control agent, liquid formulation, Bacillus thuringiensis, manufactured by Certis); RHOPLEX™ VSR-50 acrylic emulsion (obtained from The Dow Chemical Company); BOND MAX™ spreader/sticker formulation (obtained from Loveland Products); NU FILM P™ sticking-extending adjuvant (obtained from Miller Chemical & Fertilizer Corporation).

Polymer-1 was formed as follows. A solution polymerization was utilized to form a copolymer derived from diisobutylene and maleic anhydride. The wt % of polymer-1 formed from monomeric structural units to diisobutylene is from 45 wt % to 55 wt % with the remainder being maleic anhydride. The polymer was hydrolyzed with aqueous ammonia to provide Polymer-1. Polymer-1 had a weight average molecular weight of approximately 16,500 daltons.

Example 1, a spray-dried pest control composition, was formed as follows. Polymer-1 (11.6 grams) and THURICIDE™ (88.4 grams) were added to a container and agitated to provide a formulation; the formulation was fed into a MOBILE MINOR™ spray-dryer (GEA Process Engineering Inc.) using a peristaltic pump (Masterflex L/S). A fountain two-fluid nozzle atomizer was equipped on the spray-dryer. Nitrogen pressure supplied to the nozzle atomizer was fixed at 1 bar with 50% flow, which is equivalent to 100 L/min of flow. The inlet temperature was set to 120° C., and the outlet temperature was equilibrated between 40 and 50° C. at a fixed liquid feed rate (20 g/min); spray-drier output was collected by a cyclone connected to the spray-dryer to provide Example 1. Example 1 had an average particle size of approximately 41.19 microns using Laser Diffraction. Example 1 was visually observed to be a flowable powder.

Comparative Example A was formed as Example 1 with the change that RHOPLEX™ VSR-50 emulsion (5.6 grams) was utilized rather than the Polymer-1, and THURICIDE™ Bacillus thuringiensis formulation (94.4 grams) was utilized.

Comparative Example B was formed as Example 1 with the change that NU FILM P™ sticking-extending adjuvant was utilized rather than the Polymer-1. However, spray-drying the solution of NU FILM P™ sticking-extending adjuvant and THURICIDE™ Bacillus thuringiensis formulation was not able to provide a spray-dried powder.

Comparative Example C was formed as Example 1 with the change that BOND MAX™ spreader/sticker formulation was utilized rather than the Polymer-1. However, spray-drying the solution of BOND MAX™ spreader/sticker formulation and THURICIDE™ Bacillus thuringiensis formulation was not able to provide a spray-dried powder.

Comparative Example D was formed as Example 1 with the change that the Polymer-1 was not utilized.

Example 2, an aqueous pest control composition, was formed as follows. Example 1 was diluted with water to provide a mixture having a concentration of 71.4 grams/liter of the pest control agent (Bacillus thuringiensis) to provide Example 2.

Comparative Example E was formed as Example 2 with the change that Comparative Example A was utilized rather than Example 1.

Comparative Example F was formed as follows. Comparative Example D was combined with water and mixed with a magnetic stir bar to provide a mixture having a concentration of 71.4 grams/liter of the pest control agent.

Residual protein concentrations and pest control agent (Bacillus thuringiensis) activities for Example 2 and Comparative Examples E and F were determined as follows; residual protein concentrations and pest control agent activities for aqueous pest control compositions formed from Comparative Examples B-C were not determined because spray-dried powders for these Comparative Examples were not attainable.

Pieces of parafilm (2 inches by 4 inches) were respectively placed on a black Leneta card and a Kimwipe was gently rubbed over the parafilm before removing the parafilm paper. An auto-pipettor was used to randomly place 15 drops (15-30 μL) of Example 2 and Comparative Examples E and F in an array on the respective parafilms, one parafilm for each Example/Comparative Example was utilized; the samples were vortex mixed between each set of 5 drops to maintain composition consistency. Then, the parafilms were dried in an incubator at approximately 28° C. for approximately 1 hour.

The dried parafilms were then subjected to simulated rain as follows. Each dried parafilm was respectively placed in an EXO TERRA MONSOON™ RS400 Rainfall System (fitted with 2 EXO TERRA standard nozzles without any extensions); the parafilm was 13 inches from the spray nozzle. Water was sprayed onto the parafilm at a flow rate of 1.5 liters/hour, measured at the substrate interface, for 5 minutes; after which the parafilm was allowed to dry.

Following exposure to the simulated rain, the samples were extracted. For extraction, each of the respective parafilms was cut such that each dot, resultant from the drops, was centered on an approximately 0.25-inch square. For each respective parafilm, all of the cut, dotted squares were placed into a glass vial to which Sodium Dodecyl Sulfate solution (1 milliliter, 2 wt % sodium dodecyl sulfate in water) was added. Each glass vial was then sonicated and left to soak for approximately 8 hours. Sonication was repeated three times for the extractions.

Residual protein concentrations were determined by the bicinchoninic acid assay (BCA) as follows.

PIERCE™ BCA Protein Assay Reagent A and PIERCE™ BCA Protein Assay Reagent B (both obtained from Thermo Scientific) were combined Reagent A (2 milliliters) and Reagent B (40 microliters) to form a reagent mixture.

One hundred (100) microliters of each extracted sample was placed into a respective cuvette; then the reagent mixture (2 milliliters) was added to each cuvette; and then the cuvettes were incubated at 30° C. for approximately 2 hours. Absorption values at 562 nm measured with a VARIAN CARY™ 50 UV-Visible Spectrophotometer were used to determine the residual protein concentrations. The results are reported in Table 1.

TABLE 1

| | Residual protein concentration |
|---|---|
| | (Wt % of remaining active |
| | protein after simulated rain) |
| Example 2 | 58 ± 2 |
| Comparative Example E | 0 |
| Comparative Example F | 0 |

The data of Table 1 illustrates that Example 2 had an improved, i.e., greater, residual protein concentration as compared to both of Comparative Examples E and F.

The solutions, as extracted above, for Example 2 and Comparative Examples E and F were diluted to a desired starting concentration, using a 0.1 wt % solution of TWEEN™ 20 then then serially diluted at suitable concentrations and plated. The resultant pest control agent activities are reported in Table 2.

TABLE 2

| | Bacillus | Bacillus | |
|---|---|---|---|
| | thuringiensis | thuringiensis | Bacillus |
| | activity before | activity after | thuringiensis |
| | simulated rain | simulated rain | activity retained |
| | (CFU/mL) | (CFU/mL) | (percent) |
| Example 2 | 8.98 ± 0.13 | 7.37 ± 0.11 | 100 |
| Comparative | 8.82 ± 0.10 | 8.81 ± 0.12 | 82 |
| Example E | | | |
| Comparative | 9.05 ± 0.11 | 7.63 ± 0.12 | 84 |
| Example F | | | |

The data of Table 2 illustrates that Example 2 had an improved, i.e., greater, pest control agent activity retained as compared to both of Comparative Examples E and F.

1. A spray-dried pest control composition comprising:
a polymer, wherein the polymer has a weight average molecular weight from 10,000 to 30,000 daltons and the polymer contains from 20 wt % to 100 wt % of monomeric structural units derived from a monomer with log P of from 2.0 to 6.0 based upon a total weight of the polymer; and
Bacillus thuringiensis, wherein the spray-dried pest control composition has an average particle diameter from 30 nanometers to 100 microns as measured using Laser Diffraction.

2. The spray-dried pest control composition of claim 1, wherein:
the polymer is from 50.0 wt % to 99.0 wt % of the composition based upon a total weight of a combination of the polymer and the Bacillus thuringiensis; and
the Bacillus thuringiensis is from 1.0 wt % to 50.0 wt % of the composition based upon the total weight of the combination of the polymer and the Bacillus thuringiensis.

3. The spray-dried pest control composition of any one of claim 1, wherein the polymer has a weight average molecular weight from 15,000 to 20,000 daltons.

4. The spray-dried pest control composition of any one of claim 1, wherein the spray-dried pest control composition has an average particle diameter from 1 micron to 100 microns as measured using Laser Diffraction.

5. The pest control composition of any one of claim 1, wherein the polymer is a copolymer of diisobutylene and maleic anhydride.
